(19) United States
(12) Patent Application Publication
(10) Pub. No.: US 2025/0271620 A1
(43) Pub. Date: Aug. 28, 2025

(54) GRATINGS WITH EDGE APODIZATION FOR IMPROVED MODULATION TRANSFER FUNCTION IN WAVEGUIDES

(71) Applicant: GOOGLE LLC, Mountain View, CA (US)

(72) Inventors: Ido Raveh, Waterloo (CA); Joseph Daniel Lowney, Tucson, AZ (US)

(21) Appl. No.: 18/588,127

(22) Filed: Feb. 27, 2024

(51) Int. Cl. G02B 6/34; G02B 27/01

(52) U.S. Cl. CPC G02B 6/34; G02B 27/0172; G02B 2027/0178

(57) ABSTRACT

A diffraction grating includes a plurality of diffraction features and a plurality of grooves. Each groove of the plurality of grooves is adjacent to at least one diffraction feature of the plurality of diffraction features. One or more apodization features include apodization by a varied ratio of the filled region of one or more diffractive gratings to the total period, typically known as the grating fill factor to a gradually alter one or more edges of the plurality if diffraction features of at least one optical element of a waveguide. The one or more apodization features reduce a diffraction efficiency of at least one diffraction order of the diffraction grating.

### BACKGROUND

Optical gratings are periodic structures used in waveguides to couple light in or out and introduce phase and amplitude changes to light that propagates through the waveguide. In an example, some waveguides implement diffraction gratings used as an incoupler (IC) and/or an uncoupler (OC). As light encounters the edges of a grating within a waveguide, it undergoes disruptions in both phase and amplitude. When light propagates through the waveguide, particularly at the edges of the optical gratings, the waveguide may encounter various phenomena that lead to signal distortion or loss. For example, edge effects, such as scattering, diffraction, and reflections, may cause imperfections in the transmitted signal that reduce the clarity and fidelity of the output as well as facilitate compromised visual experiences for users that may interact with augmented reality (AR) and/or virtual reality (VR) content through a head-mounted display (HMD) such as, as set of AR glasses.

Further, over the course of the light's propagation through the waveguide, the accumulated phase and amplitude changes may cause degradation in a Modulation Transfer Function (MTF). The MTF degradation is known to contribute to a decline in the ability to transmit visual information accurately. This degradation manifests as a decrease in the ability of the waveguide to transmit projected light. As a result, reduced image sharpness and/or quality for images that may pass through the waveguide may occur. Thus, the accumulated phase and amplitude discontinuities contribute to distortions and aberrations in the transmitted signals, which may facilitate a loss of clarity and fidelity in the images. Efforts to address these factors through improved optical design may be employed to minimize the MTF degradation to facilitate a more immersive and realistic visual experience for users in AR and VR environments.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a waveguide with an IC aligned with an exit pupil expander (EPE) with light configured to traverse an edge of the IC toward the OC direction that may be implemented with grating apodization with a varied diffraction grating fill factor to reduce the diffraction efficiency of the waveguide in accordance with some embodiments.

FIG. 2 is a cross-sectional view of an example of grating apodization implemented at a portion of an edge of the diffraction grating of the IC of the waveguide of FIG. 1 with a varied thickness of the diffraction grating, relative to the grating period, to increase from approximately 0% fill factor to approximately 50% fill factor in accordance with some embodiments.

FIG. 3 is a cross-sectional view of another example of grating apodization implemented at a portion of an edge of the diffraction grating of the IC of the waveguide of FIG. 1 with a varied thickness of the diffraction grating, relative to the grating period, to decrease from approximately 100% fill factor to approximately 50% fill factor in accordance with some embodiments.

FIG. 4 is a diagram that illustrates a rear perspective view of a set of AR glasses with at least one lens configured to employ implementations of the waveguides of FIGS. 1-3.

### DETAILED DESCRIPTION

Optical diffraction gratings find versatile applications, particularly within waveguides. In this context, these gratings can serve as either or both of ICs or OCs. The IC grating facilitates the incident light from a light engine to couple into the waveguide and generate guided light. Conversely, the OC grating directs a portion of this guided light out of the waveguide, typically towards a user's eye. They may include regularly spaced patterns or structures along the waveguide's surface, designed to control the propagation of light within the waveguide. One variant, the one-dimensional (1D) grating, diffracts light along the x-axis and governs light in one direction without affecting orthogonal light. A metric for diffraction gratings is diffraction efficiency in its measurement of determining the amount of optical power diffracted into a specified direction relative to the incident optical power on the grating's diffractive element. High diffraction efficiency in a 1D diffraction grating implies that a significant portion of optical power is concentrated in the desired diffraction order (+1 or −1 order), minimizing losses to other orders (e.g., 0th order). Conversely, a low diffraction efficiency indicates a loss of optical power in the desired diffraction order.

In scenarios that utilize 1D gratings within waveguides or similar setups, a high diffraction efficiency in the 1D IC grating is preferable to maximize light that couples into the waveguide. Conversely, a low diffraction efficiency is sought in the OC grating or exit pupil expander (EPE) to divert most light towards transmission/reflection 0th orders. For instance, a 1D OC grating with high diffraction efficiency for +1/−1 diffraction orders tends to produce highly uneven intensity in the emitted light, which is undesirable. In contrast, a low diffraction efficiency in the 1D OC grating directs most of the light to reflection 0th orders. As a result, a more uniform intensity is often present across an eyebox. Therefore, a low diffraction efficiency grating is typically favored for OC gratings, exit pupil expanders, and similar applications.

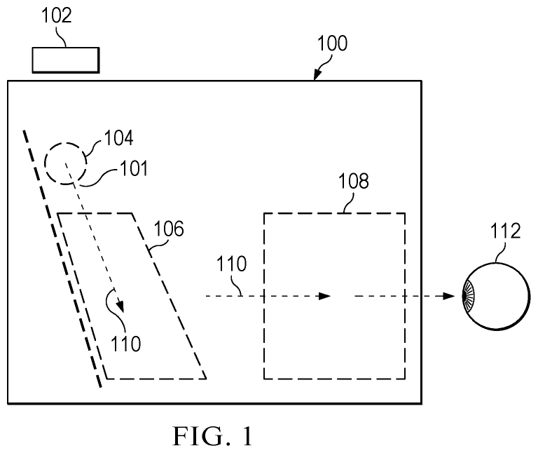

FIGS. 1-4 illustrate example processes to implement grating apodization on a waveguide by a varied thickness of the diffraction grating, relative to the grating period from values of high efficiency towards low efficiency, partially at one or more edges of optical elements such as diffraction gratings, transmission gratings, and/or reflection gratings, of a waveguide in AR and/or VR displays. This process is applicable to various categories of gratings, that include surface relief gratings and refractive index modulated gratings and may also be implemented for both 1D and two-dimensional (2D) grating configurations. The periodicity of the grating structure influences how light is diffracted through the waveguide, and causes light to bend or scatter based on the wavelength or incident angle of the light. The grating period is the distance between successive identical features in the grating structure within the waveguide. Typically, many grating periods may have the same local parameters. To ameliorate amplitude and phase disparities that occur at grating edges during light propagation within waveguides, a method is employed to establish smooth transitions. This approach aims to mitigate discontinuities, subsequently augmenting the MTF response of the waveguide. Through apodization by varying the ratio of the gratings' filled region to the total period, typically known as the grating fill factor, a gradual alteration, at one or more edges of at least one optical element of a waveguide, in phase and amplitude is initiated to facilitate a smoother transition. Thus, as a result, this may enhance the MTF for light rays traversing these transition zones during their propagation, as illustrated in FIG. 1.

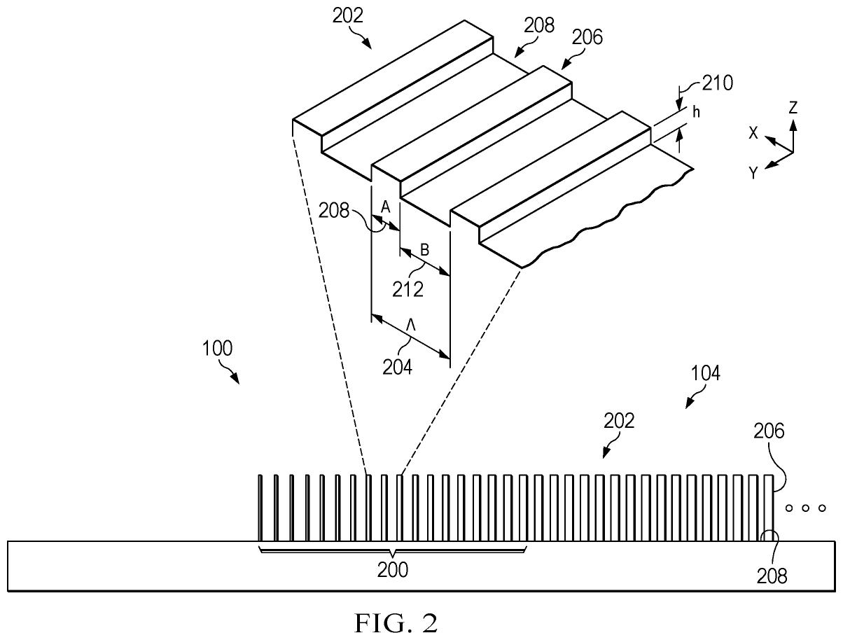

FIG. 1 illustrates an example waveguide 100 that implements grating apodization at a portion of the edge 101 of an IC 104 by employing a varied diffraction grating fill factor for reducing the diffraction efficiency of the waveguide 100. When a portion of the edge 101 of the IC 104 is substantially smooth from the grating apodization process, the MTF is improved. The illustrated waveguide 100 is suitable for pairing with a light engine 102 to facilitate light propagation the waveguide 100 and/or other reasons in accordance with embodiments. The waveguide 100, in some implementations, includes an IC 104, an EPE 106, and an OC 108. An entrance pupil of the IC 104 is configured to receive display light 110 from the exit pupil of the light engine 102 and/or another light source. In implementations that include an EPE, the EPE 106 is configured to increase the size of the display exit pupil. The position of the IC 104 typically is tied to the position of the EPE 106; that is, the IC 104 is aligned with EPE 106. In other words, they are adjusted and aligned in a way that facilitates the smooth transition of light from one component to the other. The OC 108 is configured to direct the resulting display light 110 toward a user's eye 112. This combination of components operates together for the display light to reach the user's eye in the intended manner. Although the grating apodization may be implemented at any edge portion of an optical element of the waveguide 100, the waveguide 100 employs an example of the varied thickness of each of the grating bars of a diffraction grating of an IC, relative to the grating period fill factor from values of high-efficiency to low-efficiency, as shown in FIG. 2

FIG. 2 illustrates an example of grating apodization by way of a cross-section view of a portion of an edge 200 of a diffraction grating 202 of the IC 104 of the waveguide 100 of FIG. 1. In an embodiment, the waveguide 100 comprises a volume of optically transparent material such as glass or resin and the diffraction grating 202 carried by the volume of optically transparent material. A diffraction grating 202 comprises a set of diffraction features 206 (also referred to herein as “ridges 206,” “bars 206,” or “elevations 206”). The set of diffraction features 206 are separated by a set of grooves 208 (also referred to herein as “spaces 208” or “depressions 208”), which have a low relief compared to the high relief of the set of diffraction features 206. Each diffraction feature 206 comprises a grating pitch (period) Λ 204, a grating line width A 208, a grating height h 210, and a grating space width B 212. The fill factor (duty cycle) of the diffraction grating 202 is defined as the ratio between the grating line width A 208 and the pitch Λ 204, i.e., A/Λ. The set of diffraction features 206 comprises a material having a first refractive index and the air (or other material) between each diffraction feature 206 has a second refractive index. The grating line pitch Λ 204 comprises the distance between one edge of a given diffraction feature 206 and the same edge of the adjacent diffraction feature 206.

In at least some embodiments, the grating period Λ 204 is constant throughout the diffraction grating 202. For example, the grating period Λ 204 is constant throughout the diffraction grating 202 when the grating height 210 of each respective diffraction bar 206 gradually increases and/or decreases (not shown). The grating line width A 208 comprises the fraction of the surface of the diffraction grating 202 made up of diffraction features 206. When the grating line width A 208 is wide, there are narrow grooves 208 between each diffraction feature 206, and when the grating line width A 208 is narrow, there are wide grooves 208 between each diffraction feature 206. The grating height h 210 comprises the height of the diffraction features 206.

The diffraction efficiency of each order (e.g., +1 order, 0 order, −1 order, etc.) of the diffraction grating 202 is determined by the grating height h 210 and the grating fill factor (A/Λ). Stated differently, the diffraction efficiency of each order varies as the grating line width A 208, and grating height h 210 vary. In a 1D diffraction grating, the maximum diffraction efficiency for an order typically occurs at a fill factor=0.5 and the minimum diffraction efficiency for an order occurs at fill factor values that are closer to 0 or 1. Each groove of the plurality of grooves 208 is adjacent to at least one diffraction feature 206 such as grating bar 206 of the plurality of diffraction features. As shown, the grating line width 208 of each respective grating bar 206 of the diffraction grating 202, relative to the grating period 204, increases from approximately 0% fill factor to approximately 50% fill factor.

Typically, a fill factor refers to the ratio of the width of the grating bars or slits to the period of the grating and is a parameter that influences the efficiency and performance of the diffraction grating. Diffraction grating apodization is employed to vary the grating fill factor from a high efficiency such as a fill factor=0 to a lower efficiency when the fill factor=0.5 and may be accomplished through the use of binary gratings with discrete regions of grating bars and non-bars, that allow for manipulation of the fill factor by adjusting the width of the bars and their spacing. At the edge 200 of the diffraction grating 202, one or more grating bars 206 may have a fill factor=0 with a decrease in the width of each grating bar 206 relative to the grating period, resulting in wider gaps between each of the grating bars 206 or reduced coverage of the grating surface by the grating bars 206. A fill factor=0.5 indicates the width of the bars is half the distance of the period of the grating. Thus, it represents a case where half of the grating's surface is occupied by the bars, and the other half is unoccupied space (either gaps or material between the bars, depending on the grating structure).

Apodization of grating efficiency around edges of the grating of an optical diffraction grating may be achieved through one or more changes in the grating height, grating fill factor values, shape, thickness, variable 2D sub-wavelength features, or transmission properties of optical elements. In various embodiments (not shown), the diffraction grating includes one or more of the following aspects: wherein the one or more sub-wavelength features reduce a fill factor of the at least one diffraction feature; wherein each of the one or more sub-wavelength features is a depression within the at least one diffraction feature; wherein the depression forms a discontinuity in the at least one diffraction feature; wherein the at least one diffraction feature comprises a plurality of portions separated by the one or more sub-wavelength features; wherein a pitch of the one or more sub-wavelength features is equal to a pitch of the plurality of diffraction features; or wherein the plurality of diffraction features, the one or more sub-wavelength features, and the plurality of grooves are configured such that light is only diffracted in an x-axis of the diffraction grating. In an embodiment, one or more apodization features includes one or more sub-wavelength features disposed at the one or more diffraction features.

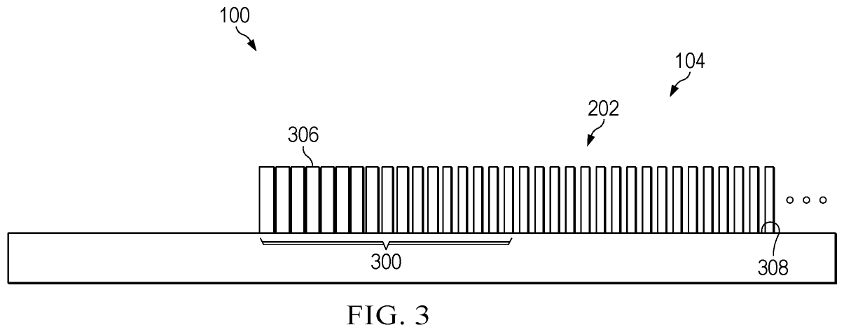

Further, a varied diffraction grating fill factor from values of high efficiency to low efficiency may include a linear or non-linear efficiency profile and may have continuous or discrete values with small steps. Another approach, that may be combined with the grating bar thickness varying process or employed solely, is varying the edge grating height (not shown) by incrementally increasing the height of one or more bars of the diffraction grating to enable a controlled variation of the fill factor along the grating surface. In another example (not shown), diffraction grating apodization involves the variation of grating fill factor from a high efficiency such as a fill factor=0.5 to a lower efficiency when the fill factor=1 or the fill factor=0 and may be accomplished through binary gratings with discrete regions of grating bars and non-bars, that allow for manipulation of the fill factor by a gradual variation of the width of the bars and the gap between the bars. When the fill factor increases towards fill factor=1, it indicates the bars substantially cover the surface of the grating, which results in a minimal space between them. When the fill factor=1, the grating bars do not exhibit low efficiency if the phase is not equal to zero. In another example, if the phase=2π, low efficiency may be achieved by grating apodization implemented at a portion of an edge of the diffraction grating of the waveguide 100 of FIG. 1 with a varied thickness of each grating bar of the diffraction grating, relative to the grating period, increasing from approximately 100% fill factor to approximately 50% fill factor as shown in FIG. 3.

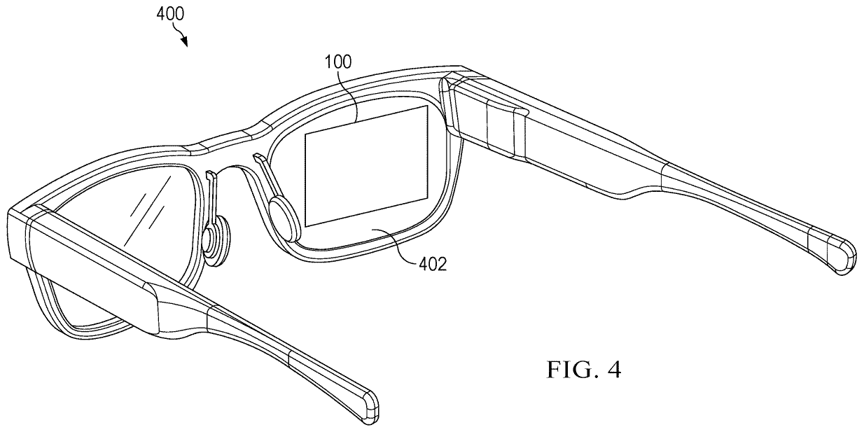

FIG. 3 illustrates another example of grating apodization through a cross-section view of a portion of an edge 300 of the diffraction grating 202 of the IC 104 of the waveguide 100 of FIG. 1 with a reversal in the varied thickness of each grating bar illustrated in FIG. 2. The diffraction grating 202 includes a plurality of diffraction features, such as the grating bar 306 and a plurality of grooves 308. Each groove of the plurality of grooves 308 are adjacent to at least one diffraction feature such as grating bar 306 of the plurality of diffraction features. The varied thickness of each grating bar 306 of the diffraction grating 202, relative to the grating period, decreases from approximately 100% fill factor to approximately 50% fill factor. As the fill factor decreases towards fill factor=0 or fill factor=0.5, there is a decrease in the width of the bars relative to the grating period, which results in wider gaps between the bars or reduced coverage of the grating surface by the bars. In an embodiment, the first grating bar has a first grating line width greater in size than a second grating line width of the second grating bar. Edge grating apodization processes described in FIGS. 1-3 may be implemented in the design of AR/VR glasses, as illustrated in FIG. 4 to create a soft transition of phase and amplitude and as a result MTF is expected to improve for rays that were bouncing across these transitions.

FIG. 4 illustrates a set of AR glasses implementing the waveguide 100 of FIGS. 1-3 formed via one or more of the processes described above. As shown, the AR glasses 400 include a set of lenses, including a lens 402 incorporating the waveguide 100. The waveguide 100 may incorporate optical features with apodization of grating efficiency as described above, such as for at least a portion of one or more edges of grating bars of a diffraction grating of an IC, an OC, or some other optical component of the waveguide.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A waveguide comprising:
a volume of optically transparent material; and
a diffraction grating carried by the volume of optically transparent material,
wherein the diffraction grating comprises:
one or more diffraction features comprising one or more apodization features; and
one or more grooves adjacent to the one or more diffraction feature.

2. The waveguide of claim 1, wherein the one or more diffraction features comprises at least one portion separated by one or more sub-wavelength features.

3. The waveguide of claim 1, wherein the one or more apodization features are implemented by varying a ratio of a filled region of a diffraction ratio to a total period.

4. The waveguide of claim 1, wherein the one or more apodization features are implemented at a portion of one or more edges of the one or more diffraction features.

5. The waveguide of claim 4, wherein the one or more apodization features are implemented by varying a height of the one or more diffraction features.

6. The waveguide of claim 4, wherein the one or more apodization features includes one or more sub-wavelength features disposed at the one or more diffraction features.

7. The waveguide of claim 4, wherein the one or more apodization features are implemented by varying a ratio of a grating line width of the one or more diffraction features to a grating pitch between successive diffraction features of the one or more diffraction features.

8. The waveguide of claim 7, wherein the one or more apodization features includes a first grating bar and a second grating bar, the first grating bar is adjacent to the second grating bar, the first grating bar has a first grating line width greater in size than a second grating line width of the second grating bar.

9. The waveguide of claim 7, wherein the one or more apodization features includes a first grating bar and a second grating bar, the first grating bar is adjacent to the second grating bar, the grating pitch increases between the successive diffraction features of the one or more diffraction features.

10. A set of augmented reality glasses implementing the waveguide of claim 1.
